(19) United States
(12) Patent Application Publication
(10) Pub. No.: US 2014/0245620 A1
(43) Pub. Date: Sep. 4, 2014

(54) Portable power tool actuating element for a jigsaw, and jigsaw

(71) Applicant: Robert Bosch GmbH, Stuttgart (DE)

(72) Inventors: Marcel Fankhauser, Bern (CH); Michael Uebelhart, Welschenrohr (CH); Miguel Da Costa, Langendorf (CH); Aldo Di Nicolantonio, Recherswil (CH); Andre Hoffmann, Riedholz (CH)

(73) Assignee: Robert Bosch GmbH, Stuttgart (DE)

(21) Appl. No.: 14/198,161

(22) Filed: Mar. 5, 2014

(30) Foreign Application Priority Data
Feb. 6, 2013 (DE) 10 2013 201 942.4
Jun. 13, 2013 (DE) 10 2013 211 072.3
Feb. 4, 2014 (DE) 10 2014 201 920.6

(51) Int. Cl. B23D 49/16; B25F 5/00; B23D 51/16

(52) U.S. Cl. CPC B23D 49/162; B23D 51/16; B25F 5/001
USPC 30/374; 30/392; 173/1

(57) ABSTRACT

A portable power tool actuating element for a jigsaw includes a bar-shaped handle that is intended to provide, at least indirectly, an on and off function for the power tool drive unit that drives at least one tool. A tool speed, in particular a tool stroke rate, is regulatable by the at least one portable power tool actuating element. A jigsaw includes the portable power tool actuating element. A method is provided for operating such a jigsaw.

The invention proceeds from a device and a method of the generic type in the independent claims.

### PRIOR ART

A device having a portable power tool actuating element for a jigsaw having a bar-shaped handle, which is intended to provide, at least indirectly, an on and off function for the power tool drive unit that drives at least one tool, is already known from DE 10 2004 042 025 A1.

### DISCLOSURE OF THE INVENTION

The invention proceeds from a portable power tool actuating element for a jigsaw having a bar-shaped handle, which is intended to provide, at least indirectly, an on and off function for the power tool drive unit that drives at least one tool. It is proposed that a tool speed, in particular a tool stroke rate, is regulatable by way of the at least one portable power tool actuating element.

The portable power tool actuating element can generally be understood to mean a human/machine interface for operating the jigsaw. However, the portable power tool actuating element should preferably be understood to mean an element which can typically be actuated in a regulating manner by way of a finger or a hand of a user of the jigsaw. It preferably has a surface and/or structure which is intended to be easily operated haptically and/or ergonomically, particularly preferably by a human finger. This may be a sensory element, preferably a touch display, and/or a slide, a regulating switch, a lever or a rotary wheel. Particularly preferably, it is an actuating element that is at least partially rotatable about a center of rotation or is linearly movable, and in particular is guided in its rotation or movement. Very particularly preferably, this actuating element can be partially lowered in its receptacle or mount, in particular in a jigsaw machine housing, at least during an actuation. Furthermore, this actuating element acts at least indirectly on at least one electrical switching means, in particular a potentiometer, and as a result forms, in terms of its function, a part of a switch. The receptacle of the actuating element is located typically at least partially on or at least partially in the housing of the power tool.

According to the invention, both an on and off function and a tool speed, in particular tool stroke rate, can be regulated via the at least one portable power tool actuating element. In this case, a tool stroke rate should be understood in particular as meaning the stroke rate of the jigsaw blade or an oscillating frequency or reciprocating frequency or speed of movement of the saw blade. The term “regulatable” should be understood in particular as meaning variably settable. Typically, an initial, preferably minimum actuation of the portable power tool actuating element from a starting position or zero position causes the jigsaw to be switched on and consequently causes a continuous movement of a reciprocating unit of the jigsaw, at least unless the portable power tool actuating element is returned to the starting position. A return displacement of the actuating element, in particular into the starting position, preferably causes the reciprocating movement of the jigsaw to end or stop and ultimately causes the jigsaw to switch off. If the portable power tool actuating element is displaced more strongly, in particular pushed, pulled, slid or rotated more strongly, a tool speed is typically increased further, or decreased further, as a result. At a maximum deflection or displacement of the portable power tool actuating element, a maximum tool speed is typically achieved. Alternatively, this regulating function can also be taken over by an automatic, autonomous control, as it is known, of the power tool and/or an autonomous tool speed assistant. The latter typically senses both the workpiece properties and the tool and jigsaw properties, for example by means of an optical sensor, a force or acceleration sensor, and automatically regulates the tool speed.

Advantageously, the regulatability, in particular the variable regulatability or controllability, according to the invention of the tool speed of the jigsaw by means of the one portable power tool actuating element that combines the function of switching on and off and the regulation of the tool speed, provides a user of the jigsaw with an easy means of controlling the tool, in particular the saw blade. Thus, for example, during an initial sawing operation or a sawing out or sawing off operation of a workpiece, the tool speed can be reduced easily. This typically increases the safety of operating the jigsaw. In addition, application-dependent and/or workplace-dependent operation is rendered easier for the user. In addition, the sawing quality can be increased by the portable power tool actuating element according to the invention, in particular by a tool speed that is intended to be adapted in a situationally easy and one-handed manner. Depending on the workpiece properties, the tool speed correlates with a vibration input, in particular into or onto the workpiece, which is easily controllable by the simple regulatability of the tool speed by means of the portable power tool actuating element. Moreover, however, the vibrations which the user of the jigsaw feels, in particular in his hand, are also easily regulatable as a result and make it easier for the user to use the jigsaw. The regulatability according to the invention of the tool speed has a particularly advantageous effect, for example in the case of an unsafe working position of the user and/or an unsafe position of the jigsaw on a workpiece to be machined, for the abovementioned reasons. Easy regulatability of the stroke rate is also advantageous in the case of an unsafe clamping situation of the workpiece, in order in particular to be able to control vibration excitation of the workpiece. This typically has a positive effect on the cutting quality and thus on the sawing result. In addition, it increases user control over the tool and prevents for example the risk of an uncontrolled first cut and/or uncontrolled restoring forces that act on the user. In this way, the comfort and safety when using the jigsaw having a bar-shaped handle are increased in a particularly advantageous manner. Moreover, the user can influence, or reduce, the appliance vibrations and/or vibration excitation of a workpiece, in particular in a targeted manner, by variable regulation of the tool speed. This has a particularly advantageous effect during a sawing operation at critical locations, at sharp changes in direction, in the case of obstacles that occur, sawing end positions that are to be met exactly and/or in the case of events that occur unexpectedly.

Advantageous developments of the portable power tool actuating element according to the invention can be gathered from the features in the dependent claims.

It is proposed that, in an advantageous embodiment, the portable power tool actuating element is intended to change, in particular to increase or to lower, the tool speed of the jigsaw, at least in dependence on a movement, in particular a deflection or rotation or pivoting movement or swiping movement, of the portable power tool actuating element. The term “intended” should be understood in particular as meaning specially designed or equipped. The fact that a portable power tool actuating element is intended for a particular function should be understood in particular as meaning that the element and/or the unit fulfills or executes this particular function in at least one use state and/or operating state. The term “movement” should be understood as meaning typically a change in location and/or position with respect to a starting position and/or previous position.

The movement is typically implemented by a hand, in particular a finger of the user. In this case, the portable power tool actuating element is displaced typically linearly or in a rotary direction preferably about a center of rotation. Particularly preferably, the portable power tool actuating element is in this case received, guided, surrounded or delimited by a bearing structure, positioning structure or holding structure. Alternatively, the portable power tool actuating element may be an electronic or optoelectronic actuating element. The latter is actuated for example by swiping, in a similar manner to how a smart phone display is used. However, acoustic actuation by specification of a sound, term or number is also conceivable, in particular a number which corresponds to the specification of the tool stroke rate.

Advantageously, a required tool speed can be controlled easily and intuitively in this way. Moreover, depending on the application, a stroke rate can be adapted or the machine switched on or off quickly.

Furthermore, it is proposed that the portable power tool actuating element is operatively connected directly or indirectly to an electrical switching means, in particular to a resistor that is variable by operator control, for example a potentiometer. The term “directly” should be understood in particular as meaning directly connected or directly coupled. Preferably, the electrical switching means is even integrated in the portable power tool actuating element or directly incorporated therein. The term “indirectly” should be understood in particular as meaning diverted via further mechanical, electronic and/or optical elements, but operatively connected together. Preferably, “indirect control” should be understood as meaning operatively connected via at least one bolt element, wire, cable, or deflection roller. Particularly preferably, operatively connected via a portable power tool actuating element arranged on an underside of the bar-shaped handle. Said portable power tool actuating element is arranged for example in a transition region between a first and second housing part of the jigsaw and pivotable about a center of rotation. The portable power tool actuating element acts in this case on a switch element, and in particular presses or pulls the latter. The switching element in turn actuates at least one electrical switching means, in particular by way of a restoring spring. Very particularly preferably, a portable power tool actuating element that is pivotable about a center of rotation acts on a cable that is typically guided in the housing. Said cable can be diverted in particular via a preferably eccentric diverting element. The eccentric diverting element can allow the cable to be adjusted and/or tensioned, for example by an in particular discretely settable rotation of the element. Furthermore, the portable power tool actuating element can act at least indirectly on a link element, which in turn typically acts on a potentiometer connected to a switching element and actuates said potentiometer. The term “operatively connected” should be understood as meaning a portable power tool actuating element which switches, controls or regulates an electrical switching means in the case of actuation. Alternatively, the portable power tool actuating element can also be connected to the electrical switching means via a hydraulic coupling system.

A direct operative connection can be particularly advantageous on account of the few components to be moved. A direct operative connection is preferably less susceptible to faults and thus more reliable than an indirect operative connection. In addition, as a result of a high level of integration of the electrical switching means in the portable power tool actuating element, an assembly can be formed, for example, which can be applied easily to a jigsaw. On the other hand, for example in the event of confined space conditions, an indirect operative connection may be preferable to the direct operative connection. Particularly preferably, further portable power tool actuating elements, which are operatively connected and/or coupled in particular to the first portable power tool actuating element, may as a result also act on a common electrical switching means.

Furthermore, it is proposed that in one embodiment the at least one portable power tool actuating element is lockable, wherein the locking is realized in particular mechanically and/or electronically, preferably by latching or clamping. In this case, the portable power tool actuating element can be moved only with a partially increased or reduced effort preferably by latching and/or clamping surfaces formed at least partially in its receptacle. The portable power tool actuating element may have one or preferably a plurality of locking means, in particular segment-forming locking means arranged at regular intervals. Alternatively, the locking means can also be provided by components that are operatively connected to the portable power tool actuating element. Preferably, locking points are rendered visible to the user and in particular provided with user-relevant information, for example labeled.

Advantageously, the portable power tool actuating element can as a result be fixed or set at a desired tool stroke rate that is in particular rendered visible to the user and/or is coordinated with a workpiece to be machined. As a result, the user gains more freedom for holding and moving with the portable power tool actuating element switched on and locked.

Furthermore, it is proposed that at least one further actuating element is at least partially integrated into the portable power tool actuating element. The further actuating element may be for example a rotating or sliding element. It may be embodied in a round or angular manner, in particular in a barrel-shaped, square or rectangular manner. It may have a haptic active surface, for example as a result of ribbing or roughening of its surface. It may differ in terms of its material from the portable power tool actuating element. Furthermore, it may appear or be actuable for example only after a particular actuating travel of the portable power tool actuating element.

Functionally, for example a blocking function of the portable power tool actuating element at the maximum deflection thereof can be realized by the further actuating element. Likewise, what is known as a switch-on inhibitor of the reciprocating saw is conceivable by way of at least indirect blocking of the portable power tool actuating element in its starting position. Advantageously, actuation of the portable power tool actuating element is thus enabled only after actuation of the actuating element, in order to prevent the reciprocating saw from unintentionally being switched on.

Moreover, the actuating element can also at least indirectly influence the operation of the reciprocating saw. In this case, the actuating element acts preferably on the reciprocating saw control. For example, a maximum stroke rate of the reciprocating saw, which the reciprocating saw must not exceed at maximum deflection of the portable power tool actuating element, can be preset by means of the actuating element. It is likewise conceivable to specify the tool speed characteristic, corresponding to the switching travel of the portable power tool actuating element, of the reciprocating saw via the actuating element. For example between a linear and nonlinear behavior of the actuating travel of the portable power tool actuating element with respect to the corresponding tool speed. In this connection, “linear” is intended to mean that a doubling of the actuating travel of the portable power tool actuating element brings about a doubling of the tool speed or the stroke rate of the reciprocating saw. By contrast, “nonlinear” is intended to characterize a for example exponential behavior. This can enable for example a sensitive, delayed increase in the stroke rate during initial actuation of the portable power tool actuating element.

Furthermore, it is conceivable for the actuating element to serve at least indirectly to specify two operating modes of the reciprocating saw or of the portable power tool actuating element. Firstly, the conventional on/off use of the bar-shaped reciprocating saw by means of actuation of the portable power tool actuating element, as is known from the prior art. Alternatively, an operating mode in which, depending on the actuation or depending on the actuating travel of the portable power tool actuating element, the tool speed is variably settable. Advantageously, the user can choose whether he wishes to use the bar-shaped reciprocating saw in the on/off operating mode known to him or the variable mode.

In a further embodiment, the portable power tool actuating element is coupled at least indirectly to a motor brake. The motor brake brakes for example the drive unit. Preferably, the motor brake acts depending on the actuating speed, in particular when the portable power tool actuating element is released. For example, the motor brake brakes the reciprocating saw drive and as a result quickly reduces the tool speed, in particular in the event that the portable power tool actuating element is released or pushed back quickly. Advantageously, typical operations with reciprocating saws, such as notching for example, can be carried out more simply and more precisely as a result. During these operations, frequent starting, brief sawing and stopping of the reciprocating saw occurs. In addition, the user safety of the reciprocating saw is increased, since so to speak an emergency stop function is integrated.

Furthermore, the invention proceeds from a jigsaw having a bar-shaped handle and a portable power tool actuating element according to the invention. On account of their ergonomic properties, jigsaws having a bar-shaped handle provide the user in principle with the possibility of taking up two or more different orientations of the jigsaw during the work operation. In a first typical application of the jigsaw having a bar-shaped handle, the jigsaw rests “from above” on the workpiece, in particular via its footplate. In this case, the tool, in particular a saw blade, is typically directed away from a viewing direction of the user. The jigsaw and workpiece conceal the free end of the tool from the sight of the user. The weight of the jigsaw is supported by the workpiece, in particular in the case of an entirely planar surface of the workpiece. In this case, the user observes the interface “from above”, at least looking toward the jigsaw and/or the workpiece. A first hand of the user typically grasps the bar-shaped handle of the jigsaw from above; if appropriate, a second hand of the user is supported and/or pressed, likewise from above, on a housing comprising at least one reciprocating unit. To this end, at least one portable power tool actuating element is arranged on a housing of the jigsaw. In particular, the portable power tool actuating element according to the invention is arranged on the bar-shaped handle of the jigsaw or in a transition region between the bar-shaped handle and at least one second housing part that accommodates the reciprocating unit or at at least one transition of the housing into a foot part. However, alternatively, a portable power tool actuating element that is arranged in a foot region or the footplate of the jigsaw is also conceivable.

In a second typical application, the jigsaw having a bar-shaped handle is operated in an “inverse” orientation or operating handling mode compared with the first application. In this case, rather than being guided on the workpiece “from above”, the jigsaw is guided on the workpiece “from below”. A free end of the tool is directed “upwardly” typically toward a user or his viewing direction or head. During sawing, the user carries the weight of the jigsaw in particular one-handedly and guides the latter at the same time. He sees or follows only the free part of the saw blade that projects through the workpiece.

Therefore, for optimal handling of the jigsaw with a bar-shaped handle, both handling “from above” and inversely thereto “from below” can be enabled easily and safely. Meanwhile, it is typical for the user to change his grip in order to achieve these two handling orientations during machining or during machining breaks. Accordingly, it is necessary to configure the portable power tool actuating element in such a manner as to be operable as far as possible safely, reliably and clearly, both with regard to right-handed or left-handed handling and also with regard to the hand position and/or finger position on the portable power tool actuating element. According to one subject of the invention, the user also has the possibility of controlling or regulating a stroke rate in a variable manner. As a result, and on account of the advantageous arrangement of the portable power tool actuating element, the advantages of more direct control of the tool speed arise for the user. In addition, these can be adapted to the local conditions, in particular to the workpiece material to be machined, the accessibility of the workpiece, the thickness of the workpiece and further workpiece properties. Furthermore, the machining quality and operating comfort, for example during the initial sawing or sawing off of the workpiece, and also the operating safety, in particular when the operator is in an unsafe position, can be increased. Furthermore, appliance vibrations or the vibration excitation of the workpiece by the jigsaw can be adapted easily and in a situation-specific manner or be influenced by the user, for example in the case of a thin or unsafely clamped workpiece. Moreover, the stroke rate, for example at critical points, in particular at sharp changes in direction, in the case of obstacles that occur and/or end positions that are to be met exactly, can advantageously be easily adapted by the user during the sawing operation, in particular without interrupting the sawing operation.

In an advantageous embodiment, the invention proceeds from a jigsaw having a housing, wherein the housing is formed at least from a first housing part that accommodates at least a reciprocating unit of the jigsaw, and a second housing part that is arranged substantially perpendicularly to the reciprocating unit and forms a bar-shaped handle of the jigsaw. The term “housing part” is also used synonymously with the term “housing region” or “housing section” here. The housing may be a one-piece, one- or multipiece housing. It can be constructed from half-shells and/or at least with a cup housing. The housing part accommodating the reciprocating unit of the jigsaw typically also comprises the transmission of the jigsaw and can therefore alternatively also be known as the transmission housing part.

Furthermore, it is proposed that the at least one portable power tool actuating element is arranged on the housing of the jigsaw, in particular on the housing part that accommodates at least the reciprocating unit of the jigsaw. Preferably, this is a region which is intuitively gripped by the user in order to hold and/or guide the jigsaw, in particular depending on the accessibility and machining task. Particularly preferably, the arrangement of the portable power tool actuating element directly adjoins the holding region, typically a top region of the second housing part or a side, facing the bar-shaped handle, of the second housing part. The user typically grips the top region with his palm, and the transition region typically both with his palm and with a hand region extending between his index finger and thumb. Accordingly, the portable power tool actuating element is arranged preferably in the finger region. Advantageously, the jigsaw can thus be guided safely and comfortably and the stroke rate can be adapted variably to the described conditions during operation.

Furthermore, it is proposed that the at least one portable power tool actuating element can be arranged on an underside or top side of the bar-shaped handle of the jigsaw. Preferably it is arranged centrally on the underside or top side. Thus, the portable power tool actuating element can be gripped in a similar manner for right-handed and left-handed machining and as a result makes actuation with a change in grip easier for the user on account of a haptically familiar recognizable feel. Particularly preferably, the portable power tool actuating element is arranged, in one embodiment, before a transition region of the first housing part, forming the handle, to the second housing part, accommodating the reciprocating unit. Thus, the portable power tool actuating element is arranged in particular close to the center of gravity of the jigsaw. Preferably, it is a portable power tool actuating element that is movable in rotation or translation, and is arranged in an at least partially lowerable manner. In particular, it is arranged centrally at least on the housing underside, in or in the vicinity of a transition region to a foot part. Alternatively, it may preferably also be arranged centrally on the top side of the bar-shaped handle.

Furthermore, it is proposed that the at least one portable power tool actuating element is arranged in the transition region between the first and second housing parts or in the transition region to a foot part. Typically, the jigsaw can preferably be guided in this region, since both a contact pressure on the workpiece and an advancing force in the sawing direction, particularly preferably in the vicinity of the center of gravity of the jigsaw, can be transferred to the jigsaw by the user. Preferably, the portable power tool actuating element is secured to the housing, or is inserted or mounted therein so as to be movable in translation or rotatable. The term “capable of displacement” is intended to define in particular a guided displacement from a position, restored for example by way of a spring into a starting position, of the portable power tool actuating element, or an intermediate or end position that differs, in particular in terms of rotation and/or translation, therefrom. In this case, for example the portable power tool actuating element can be operated via a simple lever mechanism, and in particular be acted upon with a force or a travel. This can be realized, for example, via a cable which is fastened to a lever and is preferably operatively connected to a potentiometer. Advantageously, a compact structure can thus be realized, since the electrical switching means is arranged for example in a rear region from the point of view of the housing part carrying the reciprocating unit.

Furthermore, it is proposed that, in an advantageous embodiment, the at least one portable power tool actuating element is arranged on that side of the housing part, accommodating at least the reciprocating unit of the jigsaw, that faces or faces away from the bar-shaped handle. This position is advantageous in particular for guiding and/or applying thrust in a working direction typical for the jigsaw. Thus, the jigsaw can be actuated in a user-friendly manner via the portable power tool actuating element without changing grip.

Furthermore, a jigsaw having a foot part, in particular a footplate, extending substantially parallel to the bar-shaped handle of the jigsaw is proposed, wherein the foot part can have a recess in the region of the projection of the portable power tool actuating element toward the foot part. The term “projection” should be understood here as meaning located opposite the portable power tool actuating element. The “projection” of the portable power tool actuating element arranged on the underside of the bar-shaped handle is that surface of the footplate that faces the bar-shaped handle. Said recess can advantageously increase a clear height between the footplate and handle and as a result can improve the freedom of movement for the user's hand, in particular for actuating the portable power tool actuating element. In addition, it becomes possible for the user or operator of the jigsaw to reach and actuate the portable power tool actuating element in a readily accessible, in particular readily grippable manner. Preferably, as a result, actuation can also take place with means for protecting the user, particularly preferably with means for protecting the user's hand, in particular work gloves. Furthermore, a foot can be displaced, in particular eccentrically, with respect to the stroke axis of the jigsaw and in the direction of the longitudinal axis relative to the stroke axis. Furthermore, the foot can have a shorter longitudinal extent compared with feet from the prior art. Particularly preferably, the foot covers less than three quarters of the footplate, particularly preferably around half of the footplate and very particularly preferably the foot has been displaced by more than 50%, in particular 60-90%, toward that side of the footplate that faces toward the stroke axis. As a result, the gripping point of the user's hand on the tool is displaced in the direction of the reciprocating unit or in the direction of the sawing tool. Advantageously, this results in an improved, perceptibly more direct sawing feel for the user, this making practical handling, in particular guiding for curved cuts, and holding of the jigsaw in an inverse position and in particular handling of the portable power tool actuating element easier.

Particularly preferably, an embodiment is proposed in which there is a clear height of at least 15 mm, preferably 25-60 mm and particularly preferably 30-50 mm, between the portable power tool actuating element and the foot part. Advantageously this allows ergonomically comfortable use of the jigsaw according to the invention, in particular actuation of the portable power tool element according to the invention, for different users having in particular differently sized hands. In addition, the use of means for protecting the user's hands is also possible as a result. The sawing feel thus continues to remain readily perceptible and direct. In this way, excessive introduction of torque about a transverse axis of the jigsaw—which could lead to the front of the footplate lifting off—is avoided.

Furthermore, it is proposed that the portable power tool actuating element is operable, in particular one-handedly, at least by way of the index finger or middle finger in a first position, and at least by way of the thumb in a second position which is in particular rotated through 180° with respect to the first position about the central axis of the bar-shaped housing part. In the first-mentioned case, the jigsaw rests with its footplate on the workpiece “from above”. Meanwhile, the jigsaw is guided and actuated by a user's hand. The eye or sight of the user is directed typically both onto the jigsaw and onto the workpiece and in particular the sawing region. Typically, however, the jigsaw and the workpiece conceal the free end of the tool from sight, in particular the free end of the jigsaw blade. The portable power tool element is in this case typically actuated at least with the index finger or middle finger.

By contrast, in a second application, rather than being guided over the workpiece “from above”, the jigsaw is guided over the workpiece “from below”. With respect to a workpiece, the jigsaw is at least guided, and in particular also pressed, from below with the footplate against the workpiece. The free tool end is directed “upwards” at least substantially in the user's viewing direction. In this case, the user typically guides the jigsaw one-handedly during a machining operation and in the process carries the weight of the jigsaw. He sees or follows merely the free part, projecting through the workpiece, of the saw blade. When the jigsaw is used “from below”, the portable power tool element is typically actuated with the thumb. Advantageously, the at least two most frequently occurring operating handling modes or orientations or positions of the jigsaw having a bar-shaped handle can therefore be operated or run safely and with a variable stroke rate.

Moreover, it is proposed that at least one further portable power tool actuating element may be provided, which makes it possible for the user to limit, in particular in a settable manner, a maximum or minimum tool speed, in particular stroke rate, which can be achieved by actuation of the first portable power tool actuating element. The term “provided” should be understood in particular as meaning arranged on the jigsaw, preferably on the housing, particularly preferably in the region of a top side of the housing carrying the reciprocating unit, very particularly preferably on a rear side that faces away from the housing of the reciprocating unit but is substantially parallel to the stroke axis. As a result of such a second portable power tool actuating element, a maximum speed of the tool and/or a maximum speed of the drive unit corresponding to the workpiece and/or the properties thereof can advantageously be preset. In spite of a full deflection of the first portable power tool actuating element, a maximum tool speed preset by the second portable power tool actuating element cannot be exceeded as a result. However, the tool speed continues to be regulatable in a variably regulatable or controllable manner up to this maximum speed as a result of the function of the first portable power tool actuating element.

Furthermore, it is proposed that haptic active surfaces, in particular soft grip surfaces, are arranged in the region of the portable power tool actuating elements or surrounding the latter. Advantageously, these support the user in intuitive operation. Moreover, it gives the user more hold when guiding or actuating the jigsaw and the actuating elements thereof. In addition, vibrations originating at least from the power tool and acting in particular on the user's hand are reduced as a result.

Furthermore, the invention relates to a method for operating a jigsaw having a bar-shaped handle and at least one portable power tool actuating element for switching the jigsaw on and off, in particular a jigsaw in which one portable power tool actuating element can additionally control a tool speed, in particular the stroke rate of the saw blade, in particular also in the switched-on state. Advantageously, the user is provided with a direct means for controlling the speed of the tool, in particular the saw blade, during operation of the jigsaw. The operation of the jigsaw and a variable tool speed can be set easily with this portable power tool actuating element. This has advantages for the user, in particular during an initial sawing operation or a sawing out or sawing off operation of a workpiece, and moreover increases simplicity and safety of operation of the jigsaw. In addition, it gives the user the option of controlling vibrations, in particular the introduction of vibrations into the workpiece. The sawing quality can be improved as a result in particular during initial sawing and sawing off operations, operations in confined space conditions and/or when machining thick workpieces and/or workpieces having an uneven hardness.

Furthermore, a method is proposed in which, in particular when a workpiece is being machined one-handedly, the portable power tool actuating element is operated at least by way of the index finger or middle finger in a first position, and at least by way of the thumb in a second position rotated in particular through 180° with respect thereto. This allows in particular one-handed operation of the jigsaw having a bar-shaped handle at least in the two preferred use handling modes. In particular during inverse, one-handed sawing, the user can variably control the tool speed. This includes for example smooth starting after a cut-inspection break, with the tool preferably remaining in the cutting position without advancing and without a tool stroke in the meantime.

Furthermore, a method is proposed in which at least one further portable power tool actuating element is provided, which makes it possible to limit, in particular in a settable manner, a maximum or minimum tool speed, in particular stroke rate, which can be achieved by actuation of the first portable power tool actuating element. Preferably, this further portable power tool actuating element is likewise arranged on the housing, particularly preferably on the bar-shaped handle of the jigsaw, very particularly preferably on a rear side, facing away from the reciprocating unit, of the bar-shaped handle of the jigsaw. Preferably, this is a portable power tool actuating element in the form of a rotary wheel, in particular a labeled rotary wheel, which is operatively connected to at least one potentiometer. Advantageously, at least depending on the material to be sawn, the properties thereof, the cutting requirements, in particular cutting quality, the local conditions, in particular safe or unsafe position or view of the user, at least a maximum stroke rate can be set beforehand as a result. Thus, for example, overheating of the workpiece as a result of machining, in particular as a result of an excessive tool speed, can be avoided. In addition, the cutting quality can be increased by preselecting the maximum or ideal tool speed which can be achieved at maximum actuation of the first portable power tool actuating element. For example, the user can preselect modes, in particular maximum tool speed modes and/or stroke rate modes, depending on the workpiece material. It is also user-friendly that, even at maximum actuation of the first portable power tool actuating element, at least a maximum tool speed cannot be exceeded safely, in particular depending on the workpiece and/or material to be sawn.

### DRAWINGS

Exemplary embodiments of the invention are illustrated in the drawings and explained in more detail in the following description. The drawing, the description and the claims contain numerous features in combination. A person skilled in the art will expediently also consider the features individually and combine them to form meaningful further combinations.

In the drawings:

FIG. 1 shows a schematic illustration of a jigsaw according to the invention,

FIG. 2 shows a schematic illustration of a detail of the jigsaw according to the invention having a portable power tool actuating element according to the invention,

FIG. 3 shows a schematic illustration of an extended detail of the jigsaw according to the invention in an alternative embodiment of the portable power tool actuating element according to the invention,

FIG. 4 shows a schematic illustration of a further alternative embodiment of the portable power tool actuating element according to the invention,

FIG. 5 shows a schematic illustration of the two typical operating handling modes or orientations or positions of a jigsaw having a bar-shaped handle.

### EMBODIMENTS OF THE INVENTION

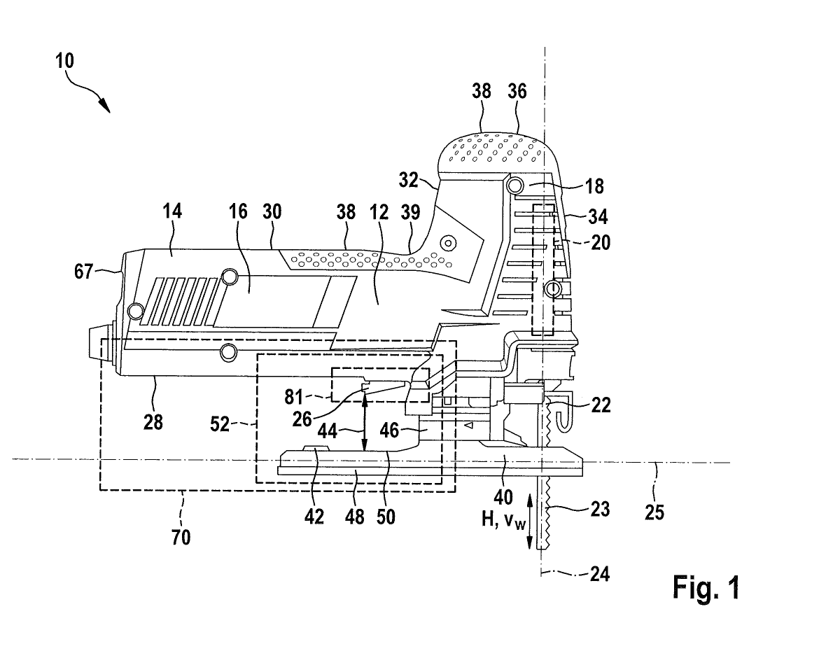

FIG. 1 shows a jigsaw 10 having a housing 12. The housing 12 is formed at least from two housing parts 14, 18. A first housing part 14 is formed by a bar-shaped handle 16 which preferably accommodates a drive machine (not illustrated in more detail here), in particular an electric motor. A second housing part 18 accommodates at least a reciprocating unit 20, typically a transmission unit (not illustrated in more detail here). The two housing parts 14, 18 should not necessarily be understood as implying a physically separate construction. The housing parts can also be formed in a one-piece manner, a multipiece manner, as a cup housing, or as half-shells individually or in combination. What is essential is the difference between the two housing parts 14, 18, in order to define at least two housing regions which are typical for a jigsaw having a bar-shaped handle.

The drive machine drives a tool 22 at least via the reciprocating unit 20. The tool 22 of the jigsaw 10 is in particular a saw blade 23 which is driven in an oscillating manner at least in the direction of a stroke axis 24.

The jigsaw can be switched on and off by actuation of a portable power tool actuating element 26. In addition, a tool speed v_{W}, in particular a stroke rate H, can be regulated or controlled according to the invention by actuation of this portable power tool actuating element 26. The regulation or control of the tool speed and/or stroke rate typically takes place continuously over a particular actuating travel b (not illustrated in more detail here) of the portable power tool actuating element 26. Preferably, this takes place proportionally to the actuating travel b. Alternatively, however, the tool speed can also follow a function f, in particular an exponential or logarithmic function, in particular also in a programmable manner, depending on the actuating travel b of the portable power tool element. Moreover, the regulation of the tool speed or stroke rate can also take place or be set digitally and/or in discrete steps. For this purpose, the portable power tool actuating element 26 can have a mechanical and/or electronic latching function (not illustrated in more detail here), wherein each latching stage corresponds in particular to a discrete tool speed. A mechanical latching system has for example stages, in particular between zero and ten stages, preferably five stages, which subdivide the kinematic actuating travel.

Furthermore, the bar-shaped handle 16 of the jigsaw has an underside 28 and a top side 30. The housing part 18 that accommodates the reciprocating unit 20 has a side 32 facing the bar-shaped handle, a side 34 facing away from the bar-shaped housing and a top side 36. For better handling, soft grip areas 38 are applied to various regions of the housing 12 at which the jigsaw 10 is typically held and/or guided. The soft grip areas 38 can also extend preferably over a housing transition region 39 between the first and second housing parts 14 and 18. In addition, the housing 12 is connected to a footplate 40, which supports the jigsaw 10 with respect to a workpiece (not illustrated in more detail here).

It is possible in principle to arrange the portable power tool actuating element 26 anywhere on the jigsaw 10, in particular on the housing 12 thereof. However, the portable power tool actuating element 26 is preferably arranged at typical holding or guiding positions of the jigsaw, for example in the transition region 39 between the first and second housing parts 14 and 18, or laterally beneath the top side 36. Particularly preferably, the portable power tool actuating element 26 is arranged, as depicted in FIG. 1, on the underside 28 of the bar-shaped handle 16, in the vicinity of a transition region region into the second housing part 18. However, it may also be arranged, starting from the underside or top side 28, 30, in a manner transitioning into the second housing part 18, preferably in the transition region of the side 32 facing the bar-shaped handle 16. Particularly preferably, the portable power tool actuating element 26 is surrounded by soft grip surfaces 38. However, it is also conceivable to arrange the portable power tool actuating element 26 in the footplate 40 or a transition region into a foot 46.

The arrangement of the bar-shaped handle 16 is substantially perpendicular to the reciprocating unit 20, in particular to the stroke axis 24 of the reciprocating unit 20. The arrangement of the footplate 40 of the jigsaw 10 is likewise arranged substantially perpendicularly to the reciprocating unit 20 and extends in the longitudinal direction of the bar-shaped handle 16. Thus, the footplate 40 extends in the direction of a longitudinal axis 25. Typically, the footplate 40 and the longitudinal axis 25 of the bar-shaped handle 16 are arranged in a manner substantially parallel to one another.

Between a top side 42 of the footplate and the underside 28 of the bar-shaped handle 16 there is a clear height 44 or geometric clearance. This clear height 44 allows the user or operator of the jigsaw 10 to reach the portable power tool element 26 in a readily accessible manner and to operate it. The freedom of movement for the hand of the user can be ensured in this way and preferably also allows handling for example with gloves. The foot 46 of the jigsaw 10 is arranged between the housing 12 of the jigsaw 10 and the footplate 40. This foot 46 is arranged, with respect to the footplate 40, in the direction of the longitudinal axis 25 relative to the stroke axis 24, and in particular is arranged eccentrically. As a result, the gripping point of the user's hand on the tool is displaced in the direction of the reciprocating unit 20 or in the direction of the sawing tool 22. As a result, there is a perceptibly more direct sawing feel for the user, this making practical handling, in particular the guiding and holding of the jigsaw, easier. In addition, a footplate region 48 arises on that side of the foot 46 that faces away from the stroke axis 24. According to the invention, this footplate region 48 has in particular a recess 50 on the top side 42 of the footplate. The recess 50 increases in particular the clear height 44 and as a result likewise improves the freedom of movement for the user's hand, in particular to actuate the portable power tool element 26.

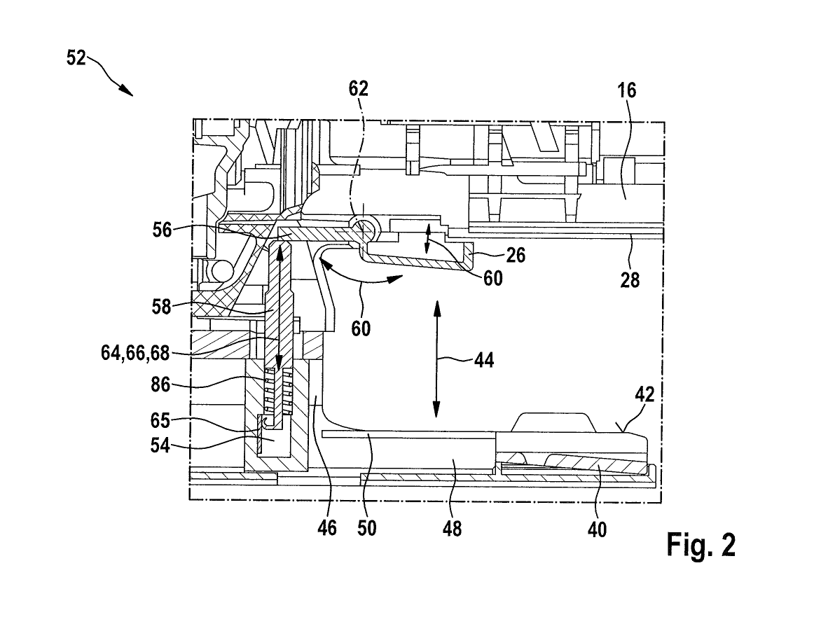

FIG. 2 shows a schematic illustration of a detail 52 of the jigsaw 10 according to the invention having the exemplary portable power tool actuating element 26 according to the invention. In this case, an electrical switching means 54 is operated at least indirectly via a lever mechanism 56. The portable power tool actuating element 26 executes a rotary movement 60 about a pivot point 62. As a result, the lever 56 is pushed in a rotary manner onto a switching element 58 that is movable in translation. The electrical switching means 54, which is arranged here by way of example in the footplate 40 of the jigsaw 10 and is embodied for example as a potentiometer, is subjected to a travel 64 or a force 66 via the lever mechanism 56 or the switching element 58. The force 66 acts on the switching element 58 at least counter to the restoring force of a spring 86. Depending on the travel 64 that is actuated, a resistance of the potentiometer that is illustrated by way of example as the electrical switching means 54 changes via a contact surface 65, the drive machine being controlled via said potentiometer. In this case, starting from the starting position of the switch, a first incremental movement of the portable power tool actuating element 26 typically effects a switching-on operation. Preferably, a further and/or stronger movement of the portable power tool actuating element 26 in the direction of the bar-shaped handle 16 further accelerates the drive unit. In a maximally deflected position, the drive unit finally reaches a maximum rotational speed or the tool reaches a maximum speed. Accordingly, the deflection travel of the portable power tool actuating element 26 corresponds preferably to a control signal for the drive unit of the jigsaw 10, which corresponds in turn to the tool speed. Thus, depending on the deflection travel, the tool speed is regulated. Particularly preferably, a maximum speed of the tool 22 and/or a maximum speed of the drive unit can be set via a further portable power tool actuating element 67 (see FIG. 1 in this regard), which is arranged additionally on the bar-shaped handle 16, in particular at the rear of the latter.

Alternatively, instead of the lever mechanism 56, direct control of the electrical switching means 54, in particular by way of a movement in translation 68 or actuation of the portable power tool actuating element 26, is also possible, for example by way of an integrated electrical switching means 54, in particular an integrated capacitive sensor. Alternatively, the portable power tool actuating element 26 can also be configured in the form of a direct linear and/or rotary slide, in particular a potentiometer (not illustrated in more detail here). Typically, the portable power tool actuating element 26 is pushed or restored into its starting position via a restoring spring (not illustrated in more detail here), which is optionally arranged in or beneath the portable power tool actuating element 26, in or on the electrical switching means 54 or the mechanical elements thereof or at some other location that appears sensible to a person skilled in the art.

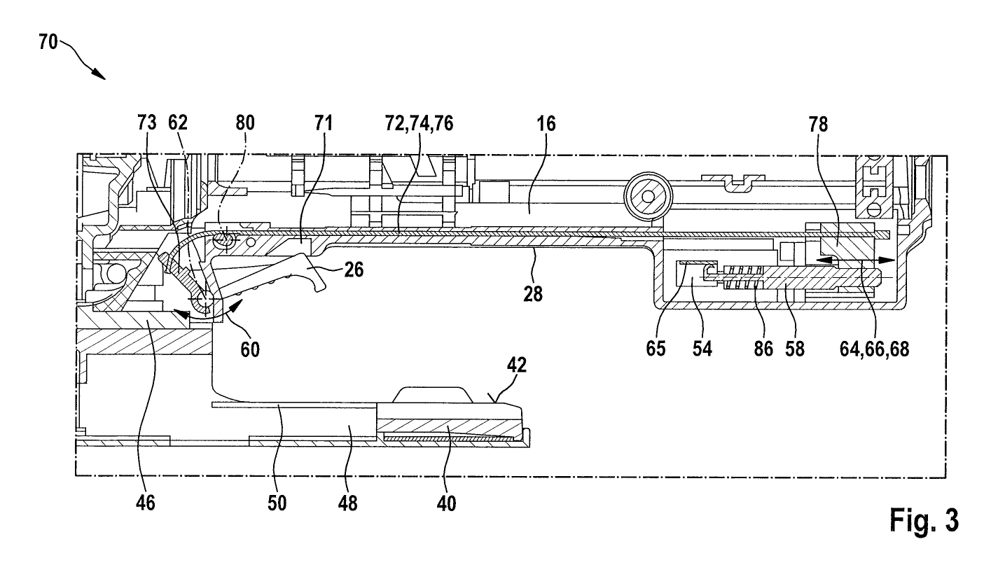

FIG. 3 shows a schematic illustration of an extended detail 70 of the jigsaw 10 according to the invention in an alternative embodiment of the portable power tool actuating element 26 according to the invention. Preferably, the portable power tool actuating element 26 is at least operatively connected to the electrical switching means 54 by means of a cable 72. The portable power tool actuating element 26 executes a rotary movement 60 about the pivot point 62. In this case, it is arranged preferably in the housing 12 of the jigsaw so as to be displaceable at least partially in a lowering recess 71. In the process, it actuates, via a lever arm 73, a pull cable 74 or pull/push rod 76, which is connected at another end to a link element 78. In this case, the pull cable 74 is diverted via a diverting point 80, in particular an eccentric element, which can also be used to tension the pull cable 74. The link element 78 initiates a movement 68 for example in translation into the electrical switching means 54 operatively connected thereto, in particular by means of the switching element 56. In this way, it is for example possible to spatially separate the portable power tool actuating element 26 and an electrical switching means 54 at least operatively connected thereto. This may be necessary in particular in order to bridge a relatively large distance between the portable power tool actuating element 26 and the electrical switching means 54. Alternatively, the portable power tool actuating element 26 and electrical switching means 54 can in this way also be arranged in different directions of movement or of releasing. Furthermore, a portable power tool actuating element 26 that is movable purely in translation or in translation and rotation, or an electrical switching means 54 can be provided for this purpose.

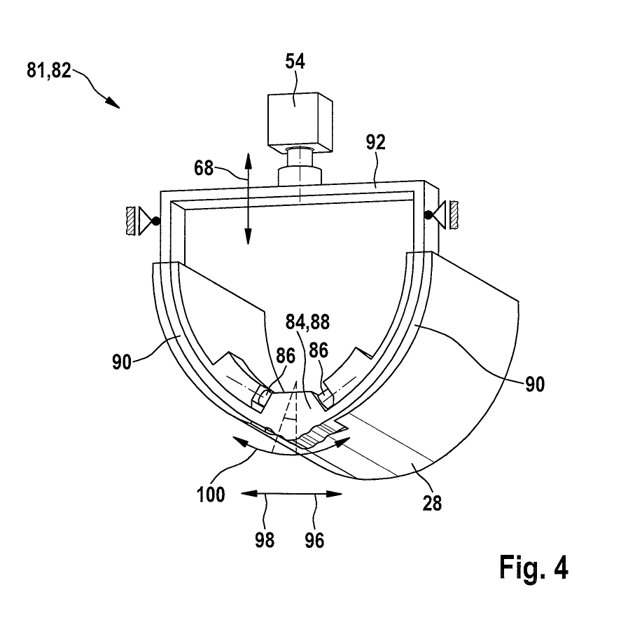

FIG. 4 shows a schematic illustration of a further embodiment of a portable power tool actuating element 82 according to the invention. The portable power tool actuating element 82 is preferably formed from an actuating element 84, which is particularly preferably placed in a starting position 88 by restoring springs 86. Slide elements 90, which are in particular elastic, are connected to the actuating element 84, preferably on both sides. Said slide elements 90 are in turn connected to a yoke slide 92 that connects the two slide elements 90. The electrical switching means 54 is coupled to the yoke slide 92. The portable power tool actuating element 82 is typically arranged so as to be pivotable about a rotation axis that extends parallel to the longitudinal axis of the bar-shaped handle 84 or about the longitudinal axis 94 of the bar-shaped handle 16. Typically, it is integrated into a housing of the jigsaw (not illustrated in more detail here), preferably into the underside 28 of the bar-shaped handle 16. Preferably, the starting position 88 arises when the actuating element 84 is oriented centrally, in particular centrally with respect to the longitudinal axis 94 of the bar-shaped handle 26. The actuating element 84 can be deflected in particular in two directions 96, 98 by a user. A deflection in a first direction 96 preferably brings about in this case the same switching reaction or actuation of the jigsaw 10 as a deflection of the actuating element 84 in a second direction 98. Preferably, the actuating element 84 is at least operatively connected to the electrical switching means 54. Particularly preferably, the actuating element 84 deflects the slide element or slide elements 90 and the yoke slide element 92, which is connected thereto and preferably executes a movement 68 in translation perpendicularly to the longitudinal axis 94, and in this way actuates the electrical switching means 54. Preferably, the deflection travel is dependent merely on the deflection angle or travel 100 of the actuating element 84. If the user releases the actuating element 84, the latter is restored to the starting position 88 by the restoring springs 86. Particularly preferably, the jigsaw 10 can thus be actuated equally well with right-handed and left-handed actuation.

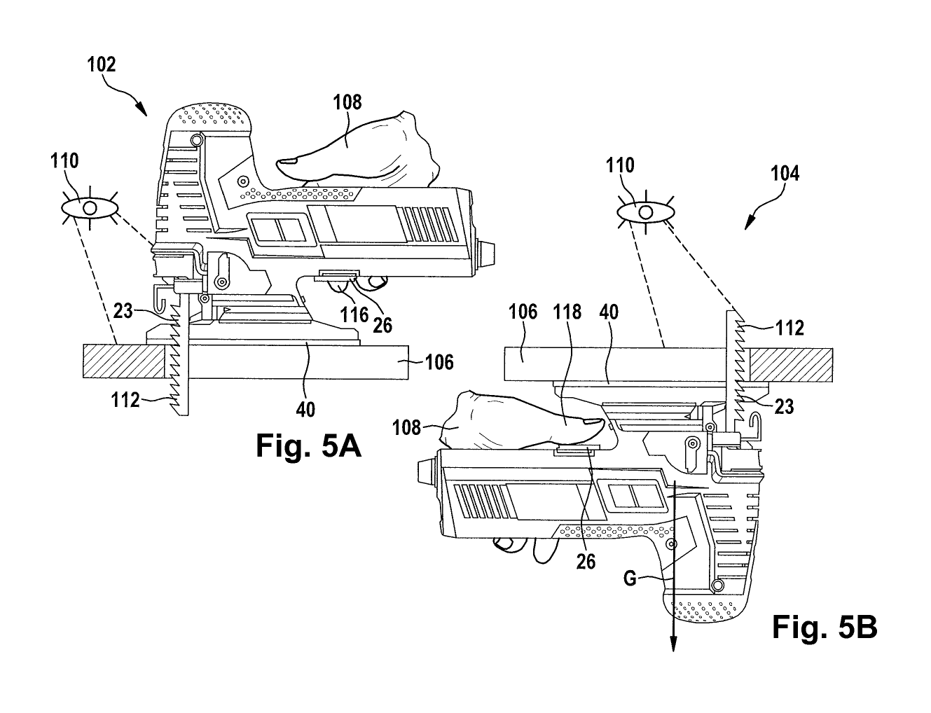

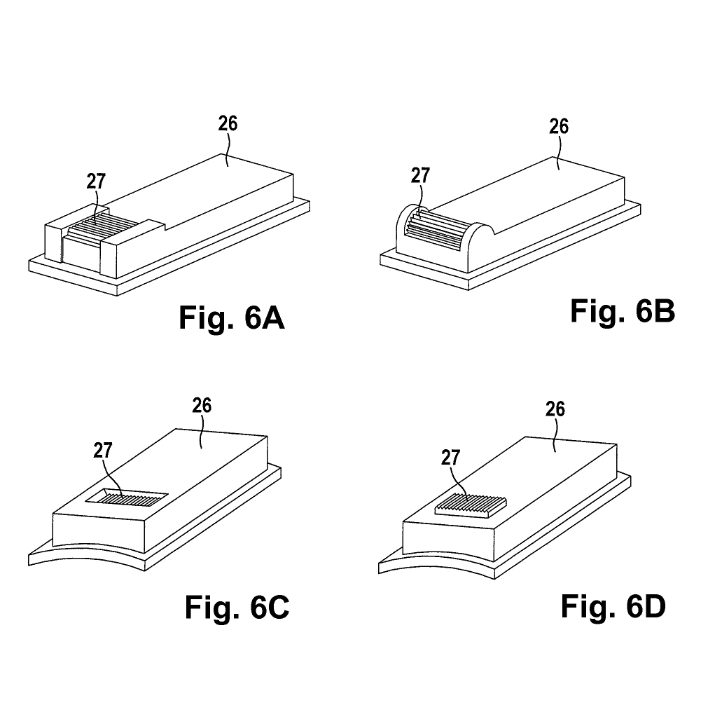

FIG. 5 shows the two typical operating handling modes or orientations or positions of a jigsaw having a bar-shaped handle 16. In the first position I, the jigsaw rests with its footplate 40 on the workpiece 106 “from above”. The jigsaw 10 is in this case guided and actuated by a user's hand 108. The eye 110 of the user looks typically both at the jigsaw 10 and at the workpiece 106 and in particular the sawing region. Typically, however, the jigsaw 10 and the workpiece 106 conceal the free end 112 of the tool 22 from sight, in particular the free end of the jigsaw blade 23. When the jigsaw 10 is used “from above”, the portable power tool element 26 is actuated typically by way of the index finger or middle finger. By contrast, the second position II shows the inverted operating handling mode or orientation or position. In this case, the jigsaw 10, rather than being guided over the workpiece 106 “from above”, is guided over the workpiece 106 “from below”. The free end 112 of the tool is directed “upwardly” toward the user. The user typically guides the jigsaw 10 one-handedly during a machining operation and in the process supports the weight force G of the jigsaw 10. He sees or follows merely the free part 112, projecting through the workpiece, of the saw blade 10. When the jigsaw 10 is used “from below”, the portable power tool element 26 is actuated typically by way of the thumb 116 of the user's hand 108.

1. A reciprocating saw, comprising:
a bar-shaped handle;
a reciprocating saw drive unit configured to drive at least one tool; and
a portable power tool actuating element configured to provide, at least indirectly, an on and off function for the reciprocating saw drive unit,
wherein one or more of a tool speed and a tool stroke rate is variably settable by the portable power tool actuating element.

2. The reciprocating saw according to claim 1, wherein the portable power tool actuating element is configured to one or more of increase and lower the tool speed of the reciprocating saw, at least in dependence on a deflection or rotation or pivoting movement or swiping movement of the portable power tool actuating element.

3. The reciprocating saw according to claim 1, wherein the portable power tool actuating element is operatively connected directly and/or indirectly to an electrical switching device.

4. The reciprocating saw according to claim 1, wherein the portable power tool actuating element is lockable, and wherein the locking is configured as one or more of mechanical locking and electronic locking by latching or clamping.

5. The reciprocating saw according to claim 1, wherein at least one further actuating element is at least partially integrated in the portable power tool actuating element.

6. The reciprocating saw according to claim 1, wherein the portable power tool actuating element is coupled at least indirectly to a motor brake.

7. A jigsaw, comprising:
a bar-shaped handle; and
a portable power tool actuating element configured to provide, at least indirectly, an on and off function for the jigsaw,
wherein one more or of a tool speed and a tool stroke rate is variably settable by the portable power tool actuating element.

8. The jigsaw according to claim 7, further comprising a housing formed at least from a first housing part and a second housing part, the first housing part accommodating at least a reciprocating unit of the jigsaw, the second housing part being arranged substantially perpendicularly to the reciprocating unit and forming the bar-shaped handle of the jigsaw.

9. The jigsaw according to claim 7, wherein the at least one portable power tool actuating element is arranged on the housing of the jigsaw on the first housing part that accommodates at least the reciprocating unit of the jigsaw.

10. The jigsaw according to claim 8, wherein the at least one portable power tool actuating element is arranged on an underside or top side of the bar-shaped handle of the jigsaw.

11. The jigsaw according to claim 8, wherein the at least one portable power tool actuating element is arranged in a transition region between the first and second housing parts.

12. The jigsaw according to claim 8, wherein the at least one portable power tool actuating element is arranged on that side of the housing part, accommodating at least the reciprocating unit of the jigsaw, that faces or faces away from the bar-shaped handle.

13. The jigsaw according to claim 10, further comprising a foot part extending substantially parallel to the bar-shaped handle of the jigsaw, wherein the foot part has a recess in the region of the projection of the portable power tool actuating element toward the foot part.

14. The jigsaw according to claim 13, wherein there is a clear height of at least 15 mm between the portable power tool actuating element and the foot part.

15. The jigsaw according to claim 7, wherein the portable power tool actuating element is operable one-handedly, at least by one or more of the index finger and the middle finger of a user in a first position, and at least by the thumb of the user in a second position that is rotated through 180° with respect to the first position about a central axis of the bar-shaped housing part.

16. The jigsaw according to claim 7, further comprising at least one further portable power tool actuating element configured to limit in a settable manner one or more of a maximum and minimum tool speed and a stroke rate by actuation of the first portable power tool actuating element.

17. The jigsaw according to claim 7, wherein haptic active surfaces are arranged in the region of the portable power tool actuating elements, the haptic active surfaces being one or more of further arranged in the region of the first portable power tool actuating element and surrounding the latter.

18. A method for operating a jigsaw having a bar-shaped handle and at least one portable power tool actuating element for switching the jigsaw on and/or off, the method comprising:
controlling one or more of a tool speed and a stroke rate (H) of the saw blade with the at least one portable power tool actuating element in the switched-on state.

19. The method according to claim 18, wherein, when a workpiece is being machined one-handedly, the portable power tool actuating element is operated at least by one or more of the index finger and the middle finger in a first position, and at least by the thumb in a second position rotated through 180° with respect thereto.

20. The method according to claim 18, further comprising limiting in a settable manner one or more of a maximum and minimum tool speed and a stroke rate with at least one further portable tool actuating element by actuation of the first portable power tool actuating element.
